(19) United States
(12) Patent Application Publication
(10) Pub. No.: US 2016/0297236 A1
(43) Pub. Date: Oct. 13, 2016

(54) Artwork Substrate

(71) Applicant: SEB IP HOLDINGS LIMITED, Chatham (GB)

(72) Inventor: Susan Edgerton-Ball, Chatham (GB)

(21) Appl. No.: 15/036,306

(22) PCT Filed: Nov. 13, 2014
(86) PCT No.: PCT/EP2014/074546

§ 371 Date: May 12, 2016

(30) Foreign Application Priority Data
Nov. 13, 2013 (GB) 1320049.8
Feb. 24, 2014 (GB) 1403206.4

(51) Int. Cl. B44D 3/18; A47G 1/06

(52) U.S. Cl. CPC B44D 3/18; A47G 1/0633; A47G 1/0605

(57) ABSTRACT

An artwork substrate including a substantially rectangular receiving portion adapted to receive an art medium, and a frame forming element extending from each side of the receiving portion. The frame forming elements are foldably connected to the receiving portion so that the substrate has a planar configuration for transportation and storage, and a folded configuration for display of artwork applied to the receiving portion. The arrangement of the frame forming elements allows the substrate to be maintained in its folded configuration without the need for adhesive.

The present invention relates to an artwork substrate and in particular to a substrate that includes a central receiving surface and side portions that are foldable to form a frame portion of the substrate.

Substrates for artwork are well known and often comprise a canvas which is treated to receive an art medium. A canvas is typically stretched across a wooden frame and may be coated with gesso, which is a traditional treatment for art canvasses and comprises lead carbonate and an adhesive derived from rabbit skin. As an alternative to gesso, the canvas may be treated with a composition comprising titanium dioxide and calcium dioxide suspended or emulsified within a polymeric carrier.

Neither gesso nor its synthetic equivalent is considered to be environmentally friendly.

In addition to environmental concerns, it is relatively difficult to secure the canvas substrate to a wooden frame to form a taught receiving surface for an art medium.

It is known to provide an artwork substrate in the form of a combined receiving surface and frame-forming portion. Such substrates avoid the need to correctly stretch and tension a canvas over a frame. However, the known substrates all require an adhesive to secure the frame forming portion in the desired configuration. The adhesive may be pre-applied in the form of an adhesive strip protected by a release layer or it may be applied during the method of forming the frame.

The present invention sets out to address or ameliorate the problems with known artwork substrates.

According to a first aspect of the invention, there is provided an artwork substrate including a substantially rectangular receiving portion adapted to receive an art medium, and a frame forming element extending from each side of the receiving portion, wherein each frame forming element includes an outer side panel foldably connected to a respective side of the receiving portion, a rear panel foldably connected to the outer side panel, an inner side panel foldably connected to the rear panel and a front panel foldably connected to the inner side panel; wherein the substrate is formed from a single sheet of substrate material, the substrate has a planar configuration and a folded configuration, and when in the folded configuration the outer side panels extend substantially perpendicularly to the receiving portion, the rear panels are arranged parallel to and spaced from the receiving portion, the inner side panels extend from the rear panels towards the receiving portion such that each inner side panel is opposite and substantially parallel to the respective outer side panel, and the front panels are arranged parallel to and adjacent to the receiving panel, whereby each frame forming element forms a rectangular section frame member on one side of the receiving portion; wherein each frame forming element includes one part of a two-part locking mechanism at each end thereof; and wherein when the frame forming elements are in the folded configuration, adjacent ends of the frame forming elements are secured together by the locking mechanism.

The present invention provides a substrate that may have a planar configuration for transportation and storage and a folded configuration for display of artwork applied to the receiving portion.

The arrangement of the frame forming elements allow the substrate to be maintained in its folded configuration without the need for an adhesive.

The skilled person will appreciate that the term “foldably connected” refers to a crease line or hinge provided between the two components which permits one of the components to be folded or hinged relative to the other component.

The art medium includes paint, printed images and three dimensional elements which may be applied or arranged for an aesthetically pleasing effect.

It will be appreciated that in its folded configuration, the substrate comprises a receiving portion which is surrounded on one side thereof with a frame formed by the frame forming elements. When referring to the receiving portion herein, the “front” side or surface of the receiving portion is considered to be the side which is bounded by the frame when in the folded configuration. The “rear” side or surface of the receiving portion is the opposite side. In embodiments which seek to recreate a “classical” art substrate, the art medium is applied to the front surface of the receiving portion and the frame projects forward from the receiving portion. However, the substrate of the invention can be used to create a more modern “box”-type substrate by applying the art medium to the “rear” surface of the receiving portion and having the frame project rearwards from the receiving portion. Thus, the front surface and/or the rear surface of the receiving portion may receive the art medium.

The substrate is in the form of a sheet of material and the material may be selected from a wood pulp material such as card, cardboard, paperboard, etc. and/or from a sheet of polymeric material.

In embodiments in which the sheet material is formed from wood pulp (e.g. selected from paper, card, cardboard, paperboard, etc.), it may be reinforced with a layer of a polymeric material. The layer of polymeric material may be 5 to 50 micrometers thick, suitably 15 to 30 micrometers thick. The polymeric material may form one or more layers applied to the rear of the wood pulp material, it may form one or more layers applied to the front of the wood pulp material or it may be one or more layers applied to both the front and rear surfaces to sandwich the wood pulp material. Thus, the sheet material may comprise a two or three layer laminate material including a layer formed from a wood pulp material and at least one layer formed from a polymeric material.

In certain embodiments, the polymer layer will be applied to the reverse of the surface intended to receive the art medium. In such embodiments, the art medium may be paint, which can be applied to a surface formed by a wood pulp material. The wood pulp material can absorb and retain the paint. Thus, in these embodiments, the polymer can provide a reinforcing layer without interfering with the ability of the receiving portion to receive the art medium.

Alternatively, where the receiving portion is printed, one or more polymer layers may be applied over the printed portion in order to protect the print.

The polymer layer(s) may provide a matt-effect finish, a silk-effect finish or a gloss-effect finish.

It will further be appreciated that two or more separate layers of a polymeric material may be applied to one or both surfaces of a wood pulp material to form the sheet material. In such embodiments, the separate polymer layers may be the same or different.

The polymer is suitably a UV stable or UV stabilised polymer in order to prevent or minimise UV degradation of the polymer layer(s). It may also form a moisture/water barrier layer to prevent moisture and/or water penetrating into the wood pulp material and having a deleterious effect.

The polymer layer may be formed from a polyalkylene polymer, such a polyethylene or polypropylene, or it may be formed from a polyester. It has been found that a polyester layer formed on the surface intended to receive the art medium provides an excellent surface to receive oil paints. Thus, for substrates intended to be used for art media including oil paints or paints/pigments having an organic carrier, the receiving portion may include an outer layer formed from a polyester. The polyester laminate material provides a suitable alternative to gesso-coated fabric substrates when the art medium comprises oil paints or paints having an organic carrier.

In addition to or as an alternative to laminated sheets comprising a layer formed from a wood pulp material (e.g. a card layer or a paper layer) and one or more polymer layers, the artwork substrate may include a canvas layer or a papyrus layer which is supported by the wood pulp layer. Such an arrangement addresses the problems of properly tensioning the canvas, as in this embodiment, the canvas is supported by the wood pulp layer and no further tensioning or framing is required. Furthermore, in embodiments in which the further layer is a papyrus layer, the wood pulp layer supports the papyrus layer. The multi-layer substrate maintains the canvas or papyrus in a substantially planar configuration for the application thereto of an art medium. The canvas suitably does not include a gesso coating.

A multi-layer substrate comprising a layer formed from a wood pulp material and a canvas layer or a papyrus layer may further include one or more polymeric layers as discussed herein.

Modern canvas is usually made of cotton or linen, although historically it was made from hemp. Thus, the present invention covers fabric layers formed from cotton, linen, hemp or mixtures thereof. The canvas of the present invention differs from other heavy cotton fabrics, such as denim, in being formed by a plain weave rather than by a twill weave. Canvas in the context of the present invention comes in two basic types: plain and duck. The threads in duck canvas are more tightly woven. It will be appreciated that the origin of the term duck comes from the Dutch word for cloth, doek rather than any reference to the water fowl bird. In the United States, canvas is classified in two ways: by weight (ounces per square yard) and by a graded number system. The numbers run in reverse of the weight so a number 10 canvas is lighter than number 4. The invention is not limited to any specific weight of canvas.

In embodiments that do not include a canvas layer, the receiving portion of the substrate may be given an appearance of canvas by providing a substrate which is textured or includes a textured portion. Thus, it may be embossed with a three dimensional texture, for example a canvas-like three dimensional texture.

Many works of art which use a traditional canvas secured to a frame achieve a “wrapping effect” in which portions of the canvas located adjacent to the outer sides of the frame also bear an image or part of an image. To replicate this effect, the receiving portion and at least the outer side panels of the frame forming element may be textured. In this way, when the substrate is arranged in its folded configuration, it provides the aesthetic effect of a “wrapped” canvas. In the context of this embodiment, it will be appreciated that one or more art media may be applied to the outer side panel in addition to the receiving portion.

Conventional artwork frames often include mitred corners at the joints between adjacent frame members (i.e. the in use vertical and horizontal frame members). In order to replicate this effect, the frame forming elements may be shaped to provide the appearance of mitred corners when the substrate is secured in its folded configuration. Thus, the rear panels of at least two of the frame forming elements include angled end portions which provide a mitred effect when the frame forming elements are in their folded configuration. In certain embodiments, two opposing frame forming elements include rear panels that have angled portions at each end. The angled portion is suitably a terminal portion of the rear panel which is angled at about 45° to the fold line or hinge between the outer side panel and the rear panel.

In an embodiment of the invention, the parts of the two-part locking mechanism are selected from locking tabs, channels and slots, wherein the locking tabs, channels and slots are defined by the respective frame forming elements. Thus, in an embodiment of the invention, each two-part locking mechanism includes a locking tab and a corresponding slot, such than when the two adjacent frame forming elements are correctly oriented in the folded configuration, a locking tab defined by a one of the frame forming elements may be secured within a corresponding slot defined by the other, adjacent frame forming element. The interengagement of the two parts of the locking mechanism forms a secure joint between the adjacent frame forming elements, without the need for an adhesive or any other strengthening components. This embodiment provides one locking mechanism per corner of the frame.

In an alternative embodiment, each end of the frame forming elements includes a locking tab, wherein each locking tab is engaged or located within a corresponding channel defined by the adjacent frame forming element. The interengagement of the locking tabs at each end of the frame forming elements with a corresponding channel forms a secure joint between the adjacent frame forming elements. In this embodiment, it will be appreciate that this embodiment provides two locking mechanism per corner. More specifically, for each corner, there is a first frame forming element and a second, neighbouring frame forming element. Each of the frame forming elements in this embodiment includes two locking tabs, one at each end. Therefore, at the joint between the first and second frame forming elements, there are two tabs, one from the first frame forming element and one from the second frame forming element. Each of these two tabs is engaged with a corresponding channel defined by the other frame forming element. Thus, two locking mechanisms are formed, with each locking mechanism defined by a locking tab and a respective channel.

When in the folded configuration, the rear panel suitably overlies the front panel such that the four panels of the frame forming element define a frame member having a substantially rectangular cross section. This is compared with other possible arrangements in which the front panel may be located parallel and adjacent to the receiving portion, but extend away from the respective edge of the receiving portion, rather than towards it. In this arrangement, the frame member formed by the frame forming element in a folded configuration, has a greater strength and rigidity.

In an embodiment of the invention, the rear panel and the front panel of each frame forming element have substantially the same width and in the folded configuration, the distal edge of the front panels engages the outer side panel. This arrangement helps to maintain the inner side panel substantially parallel to the outer side panel and provides frame members having a rectangular configuration.

In the context of this embodiment, the term “width” refers to the distance between neighbouring fold lines or creases that define the relevant panels.

In a further embodiment of the invention, the outer side panel, the rear panel, the inner side panel and the front side panel of each frame forming element has substantially the same width whereby the rectangular section frame member has a substantially square section in the folded configuration.

When the substrate is secured in the folded configuration and has had art media applied to it, it is usually desirable to display the substrate. Suitably, the substrate may be secured to a vertical surface, such as a wall. To assist with the securing of the substrate to a vertical surface, one or more of the rear panels may include an aperture or a notch via which the substrate may be secured to a vertical surface. For example, a hook, nail or similar fixing may be partially driven into the wall, such that a portion of the hook, nail or similar fixing projects from the wall. This projecting portion of the fixing may be located within the aperture or notch to secure the substrate to the wall.

To add strength to the corners of the frame formed by the frame forming elements in the folded configuration, adjacent outer side panels of the frame forming elements may be joined by a gusset (i.e. a substantially triangular or rhomboid shaped web of the substrate sheet material).

It will be appreciated that the substrate, when in its folded configuration, defines an open void on its nominally front side. It may be desired to close or partially close the void. Accordingly, two or more of the inner side panels may define an elongate slot which is arranged (i.e. shaped and sized) to receive therein a respective portion of a cover element. Suitably, all four of the inner side panels define a respective elongate slot. The cover element may be a substantially planar element. Thus, the artwork substrate may further include a cover element, locatable in use within two or more slots defined by the inner side panels.

The cover element may be transparent, translucent or opaque. Furthermore, the cover element may carry a lighting assembly to illuminate the receiving portion.

As well as the application of a hand applied artistic media (for example, paint) to the receiving portion and optionally the outer side panels, images may be printed onto the substrate. In order for the substrate to be more easily utilised in combination with a printer, a second aspect of the invention is provided.

According to a second aspect of the invention, there is provided an art substrate blank including a border portion and an artwork substrate as defined anywhere herein in its planar configuration, wherein the artwork substrate is detachably secured to the border portion by lines of weakness.

In this embodiment, the art substrate blank may be in the form of a rectangular sheet, suitably of a convenient size for use with known printers. The art substrate blank may then be fed into the printer wherein an image is applied to the substrate. The artwork substrate may then be detached from the border portion and arranged in the folded configuration.

Suitably, the lines of weakness include perforations.

According to a third aspect of the invention, there is provided a two-part artwork substrate, wherein the first part comprises a substantially rectangular receiving member adapted to receive thereon an art medium; the second part comprises a one-piece frame forming element and the receiving member is releasably coupled to the frame forming element, wherein the frame forming element includes a substantially rectangular base panel, four outer side panels each foldably connected to a respective side of the base panel, a rear panel foldably connected to each of the outer side panels, an inner side panel foldably connected to each of the rear panels and a front panel foldably connected to each of the inner side panels; wherein the frame forming element is formed from a single sheet of substrate material, the substrate has a planar configuration and a folded configuration which defines a four-sided rectangular frame, and when in the folded configuration the outer side panels extend substantially perpendicularly from the base panel, the rear panels are arranged parallel to and spaced from the base panel, the inner side panels extend from the rear panels towards the base panel such that each inner side panel is opposite and substantially parallel to the respective outer side panel, and the front panels are arranged parallel to and adjacent to the base panel; wherein each side of the frame forming element includes one part of a two-part locking mechanism at each end thereof; and wherein when the frame forming element is in its folded configuration, adjacent ends of the sides are secured together by the locking mechanism.

It will be appreciated that the difference between the first aspect of the invention and the third aspect of the invention lies principally in the base panel: in the first aspect, the base panel is a continuous rectangular substrate which defines the receiving member or portion of the art substrate, whereas in the third aspect of the invention, the base panel may support the receiving member, which is defined by a separate component that is releasably coupled to the frame forming element.

In an embodiment of the third aspect of the invention, the base panel defines a rectangular aperture. In this way, the portion of receiving member which lies within the aperture is visible in use. Thus, the base panel in this embodiment forms a part of the frame for the receiving member.

In an embodiment of the third aspect of the invention, the frame forming element may define a channel in its folded configuration, wherein the channel is adapted to receive therein the receiving member. For example, a gap may be defined between the front panels and the base panel to define a rectangular channel into which the receiving member may be located. In such an embodiment, three sides of the frame forming element may be arranged in their folded configuration, the receiving member may be located within the three sides of the channel defined by the three sides of the frame forming element, and the fourth side may be folded to complete the frame and lock in place the receiving member. As the receiving member is received within the frame forming element in this embodiment, the base panel may define a rectangular aperture in this embodiment to function as a viewing window for the receiving member.

Alternatively, the base panel or the rear panels together may define one or more slots, or carry one or more locking tabs, and the receiving member may carry or define the other of the locking tabs and slots such that the receiving member may be releasably secured to one face of the frame forming element in its folded configuration via a locking tab/slot arrangement. It will be apparent to the skilled person that there are other ways of releasably securing the receiving member to the frame forming element when in its folded configuration. It will also be appreciated that the receiving member may be secured to either face of the frame forming element.

The skilled person will appreciate that the features described and defined in connection with the aspects of the invention and the embodiments thereof may be combined in any combination, regardless of whether the specific combination is expressly mentioned herein. Thus, all such combinations are considered to have been made available to the skilled person.

An embodiment of the invention will now be described, by way of example only, with reference to the accompanying drawings in which:

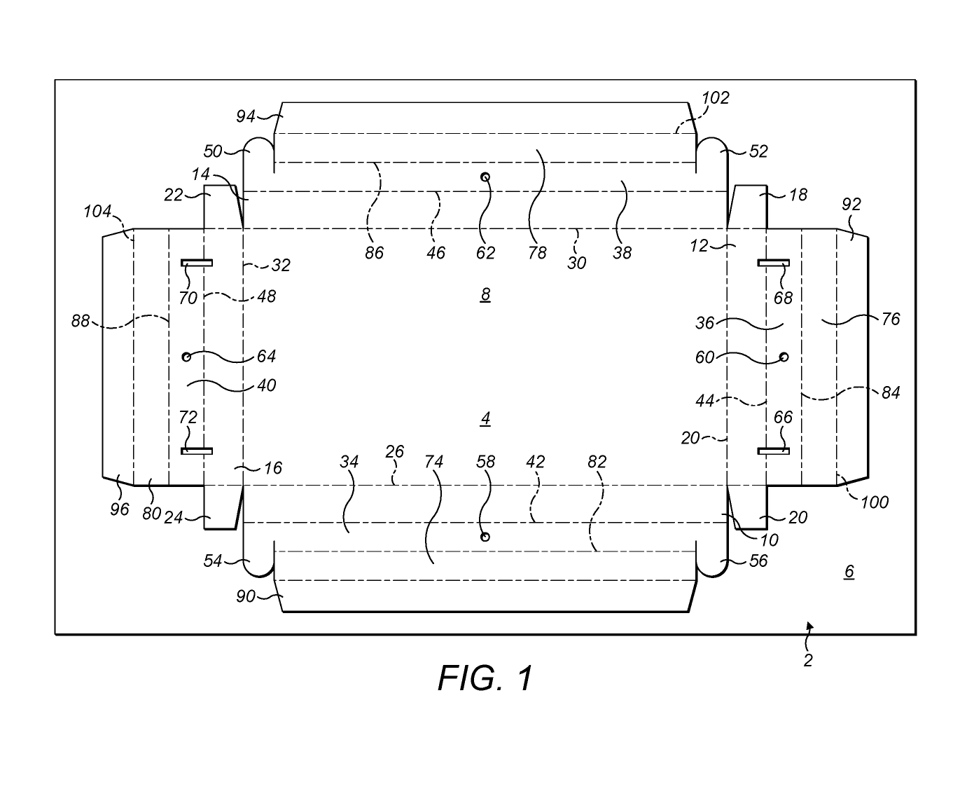

FIG. 1 is a plan view of an art substrate blank according to the second embodiment;

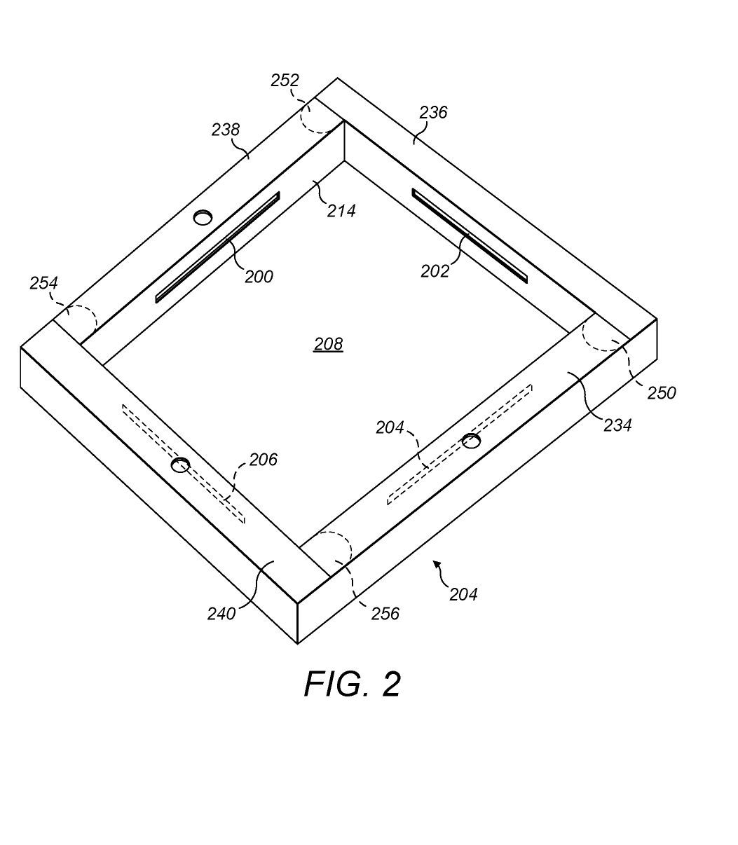

FIG. 2 is a perspective view of an embodiment of an art substrate according to the first aspect of the invention in its folded configuration;

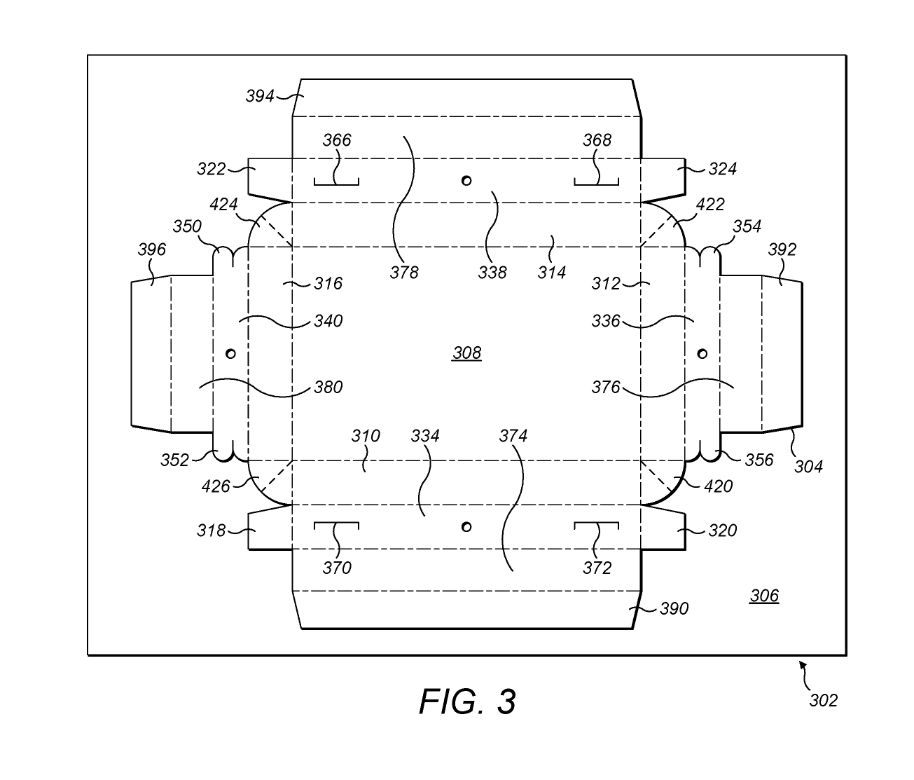

FIG. 3 is a plan view of a second embodiment of an art substrate according to the first aspect of the invention in its planar configuration;

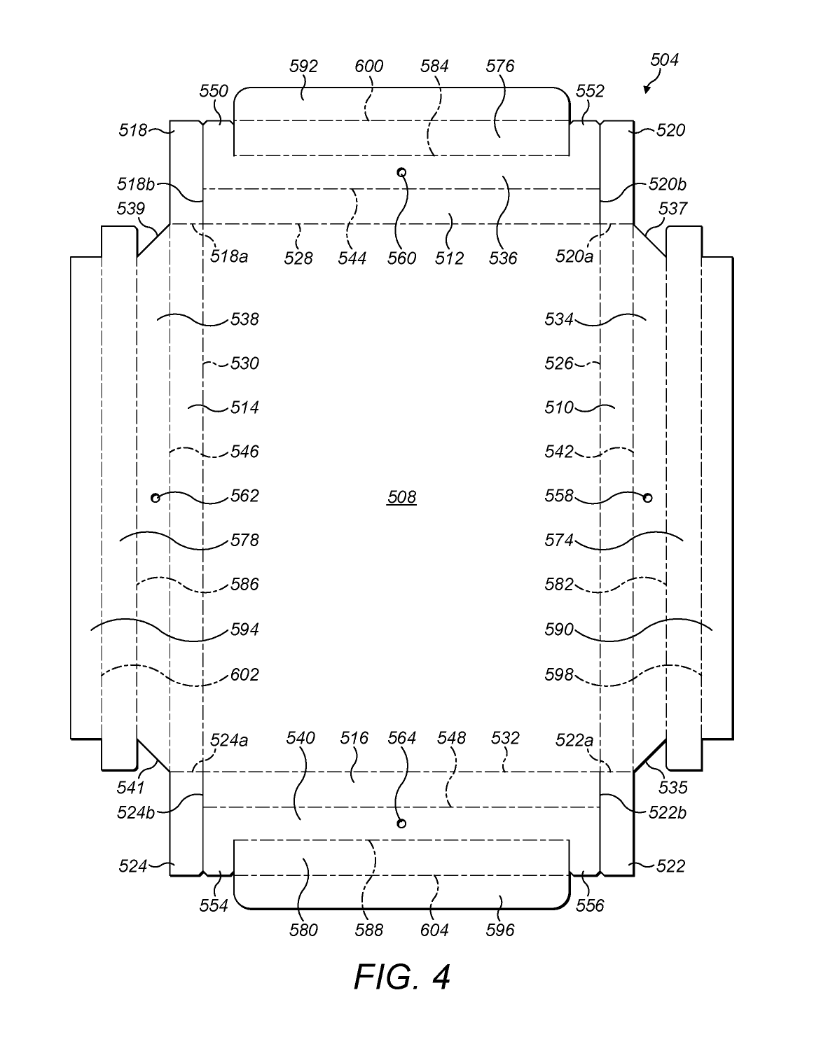

FIG. 4 is a plan view of a third embodiment of an art substrate according to the first aspect of the invention in its planar configuration;

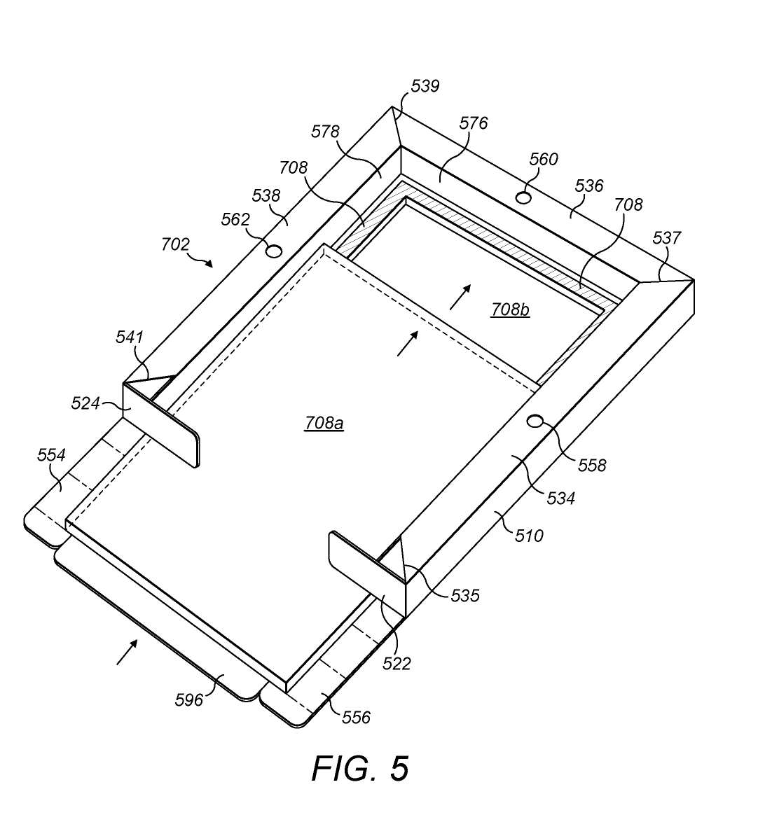

FIG. 5 is a perspective view of an art substrate according to the third aspect of the invention in its part-folded configuration;

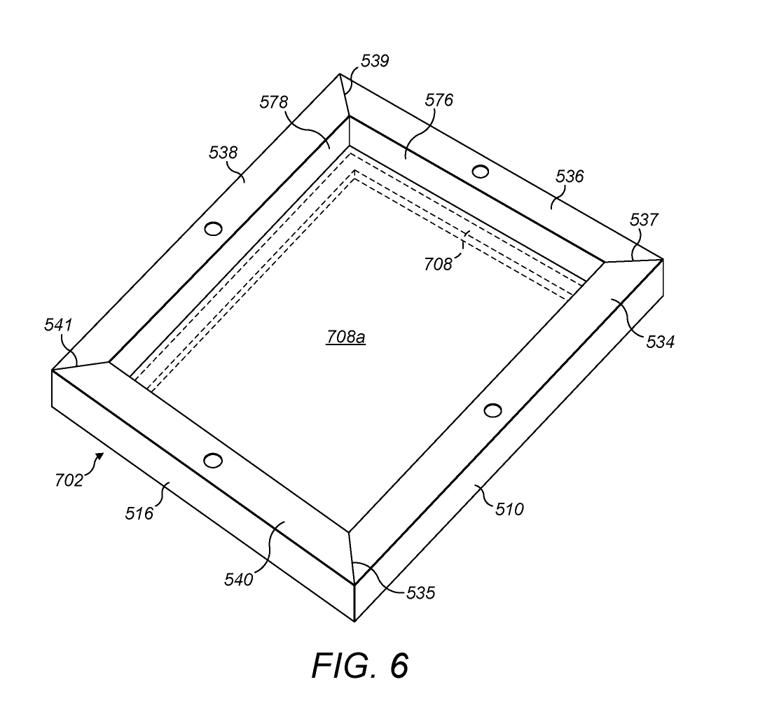

FIG. 6 is a perspective view of the art substrate shown in FIG. 5 in its fully folded configuration;

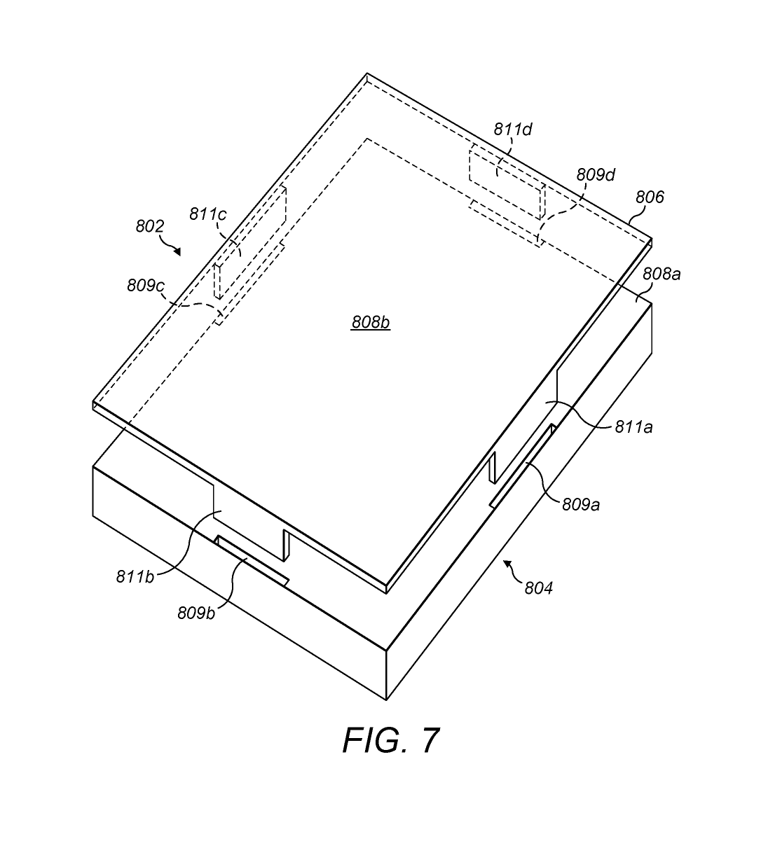

FIG. 7 is a perspective view of a second embodiment of an art substrate according to the third aspect of the invention with the receiving member separate from the frame forming element; and

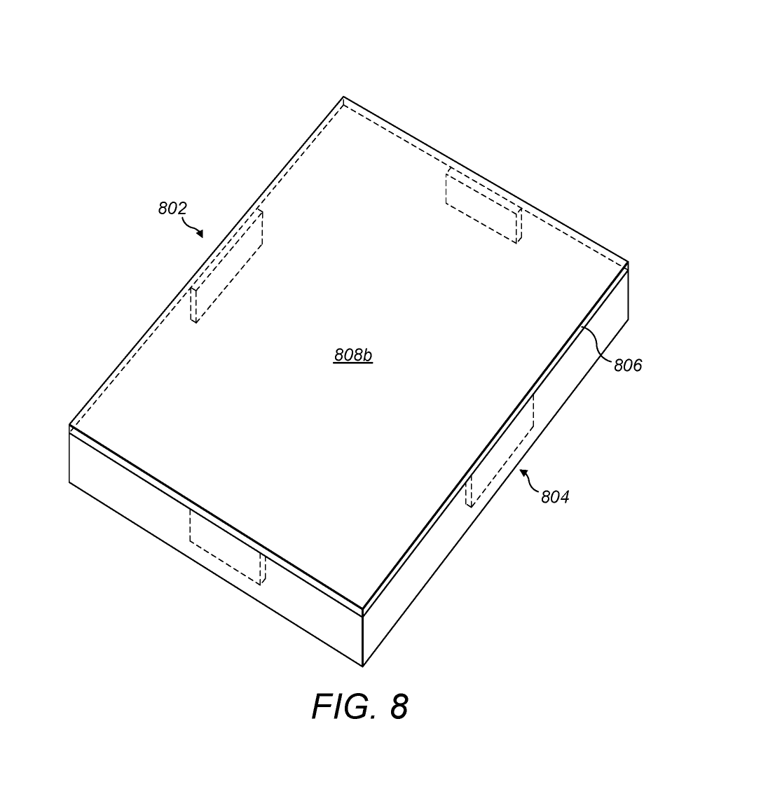

FIG. 8 is a perspective view of the art substrate shown in FIG. 7 with the receiving member secured to the frame forming element.

For the avoidance of doubt, the skilled person will appreciate that in this specification, the terms “up”, “down”, “front”, “rear”, “upper”, “lower”, “width”, etc. refer to the orientation of the components as found in the example when configured for normal use as shown in the Figures

FIG. 1 shows an art substrate blank 2 comprising an art substrate 4 surrounded by a web of border material 6. The web of border material 6 is secured to the art substrate 4 by lines of weakness in the form of perforations located around the peripheral edge of the art substrate 4.

The art substrate 4 is formed from a single sheet of material and includes a receiving portion 8 adapted to receive thereon art media. The receiving portion 8 is textured which was achieved via an embossing process.

Extending outwardly from each side of the receiving portion 8 is an outer side panel 10, 12, 14, 16. Extending longitudinally from each of the two opposed outer side panels 12, 16 are reinforcing tabs 18, 20, 22, 24. The reinforcing tabs 18, 20, 22, 24 reinforce the corners of the frame when the art substrate 4 is in its folded configuration.

The outer side panels 10, 12, 14, 16 fold relative to the receiving portion 8 via fold or crease lines 26, 28, 30, 32.

Foldably connected to the outer side panels 10, 12, 14, 16 are rear panels 34, 36, 38, 40. The rear panels 34, 36, 38, 40 fold relative to the outer side panels 10, 12, 14, 16 via a second set of fold or crease lines 42, 44, 46, 48.

Locking tabs 50, 52 extend transversely from the ends of the rear panel 38 and corresponding locking tabs 54, 56 extend transversely from the ends of the rear panel 34.

Each of the rear panels 34, 36, 38, 40 defines an aperture 58, 60, 62, 64 from which the art substrate may be suspended or via which the art substrate may be secured to a vertical surface.

The rear panel 36 further defines a pair of slots 66, 68 which are sized and shaped to receive respective locking tabs 52, 56. The rear panel 40 defines corresponding slots 70, 72 which are shaped and sized to receive locking tabs 50, 54.

Extending outwardly from the rear panels 34, 36, 38, 40 are inner side panels 74, 76, 78, 80. The inner side panels 74, 76, 78, 80 are foldable relative to the rear panels 34, 36, 38, 40 via fold lines 82, 84, 86, 88.

Extending outwardly from the inner side panels 74, 76, 78, 80 are front panels 90, 92, 94, 96. The front panels 90, 92, 94, 96 are foldable relative to the inner side panels 74, 76, 78, 80 via fold lines 98, 100, 102, 104.

In use, the art substrate 4 is detached from the blank 2 by separating the perforations which join the substrate 4 to the web of border material 6.

Once separated, the outer side panels 12, 16 are rotated upwards about their respective fold lines 28, 32 until the outer side panels 12, 16 are substantially perpendicular to the receiving portion 8. The reinforcing tabs 18, 20 are folded inwards so that they lie parallel to the respective fold lines 30, 26. Similarly, the reinforcing tabs 22, 24 are folded inwards so that they lie parallel to the respective fold lines 30, 26.

The outer side panels 10, 14 are then rotated upwards about their respective fold lines 26, 30 until the outer side panels 10, 14 are also substantially perpendicular to the receiving portion 8. In this configuration, the reinforcing tabs 18, 20, 22, 24 are located inside the outer side panels 10, 14 and are adjacent to the relevant portions of the outer side panels 10, 14.

The rear panels 34, 36, 38, 40 are then rotated inwardly about their respective fold lines 42, 44, 46, 48 so that the rear panels 34, 36, 38, 40 are parallel to and overlie a portion of the receiving portion 8. The rear panels 34, 36, 38, 40 are spaced from the receiving portion by the width of the outer side panels 10, 12, 14, 16.

The inner side panels 74, 76, 78, 80 are then rotated about their respective fold lines 82, 84, 86, 88 such that the inner panels 74, 76, 78, 80 are arranged substantially parallel to the outer side panels 10, 12, 14, 16.

The front panels 90, 92, 94, 96 are then folded about their respective fold lines 98, 100, 102, 104 and passed through the gap defined between the inner side panels 74, 76, 78, 80 and the receiving portion 8 such that the front panels 90, 92, 94, 96 are arranged to lie adjacent to the portion of the receiving portion 8 which is overlaid by the rear panels 10, 12, 14, 16.

The locking tabs 50, 52, 54, 56 are then inserted into their respective slots 70, 68, 72, 66 to secure the substrate 4 in its folded configuration without the need for an adhesive.

FIG. 2 shows an alternative embodiment of the invention in which the inner side walls of the artwork substrate include slots 200, 202, 204, 206. The slots are shaped and configured to receive therein a rigid planar cover element (not shown).

FIG. 3 shows a further alternative embodiment of the invention. In the embodiment shown in FIG. 3, an art substrate blank 302 includes an art substrate 304 and a web 306 of border material.

The art substrate 304 is generally as shown in FIG. 1 in the sense that it includes a receiving portion 308, outer side panels 310, 312, 314, 316; rear panels 334, 336, 338, 340; inner side panels 374, 376, 378, 380 and front panels 390, 392, 394, 396 which are arranged similarly to the corresponding panels of the first embodiment. Each of the panels is joined to a neighbouring panel or the receiving portion 308 by a corresponding fold or crease line.

The main differences are in the arrangement of reinforcing tabs 318, 320 which are provided at opposite ends of the rear panel 334 and of reinforcing tabs 322, 324 which are provided at opposite ends of the rear panel 338.

In addition, locking tabs 350, 352 extend longitudinally from the rear panel 340 and locking tabs 354, 356 extend longitudinally from the rear panel 336. These locking tabs are shaped and sized to locate within corresponding slots. Thus, the locking tabs 350, 354 are shaped and configured to be received by slots 366, 368 defined by the rear panel 338, and the locking tabs 352, 356 are shaped and configured to be received by slots 370, 372 defined by the rear panel 334.

In place of the reinforcing tabs 18, 20, 22, 24, the outer side walls are reinforced by gussets 420, 422, 424, 426. More specifically, the outer side walls 310, 312 are reinforce by the gusset 420, the outer side walls 312, 314 are reinforced by the gusset 422, the outer side walls 314, 316 are reinforced by the gusset 424, and the outer side walls 316, 310 are reinforced by the gusset 426.

FIG. 4 shows a further embodiment of the art substrate.

The art substrate 504 is formed from a single sheet of material and includes a receiving portion 508 adapted to receive thereon art media. The receiving portion 508 is textured which was achieved via an embossing process.

Extending outwardly from each side of the receiving portion 508 is an outer side panel 510, 512, 514, 516. Extending longitudinally from each of the two opposed outer side panels 510, 514 are reinforcing tabs 518, 520, 522, 524. The reinforcing tabs 518, 520, 522, 524 reinforce the corners of the frame when the art substrate 504 is in its folded configuration. The reinforcing tab folds about fold line 518a and it is separated from the outer side panel 512 by a slit 518b. A similar arrangement of fold lines 520a, 522a, 524a and slits 520b, 522b, 524b are provided for the other reinforcing tabs 520, 522, 524.

The outer side panels 510, 512, 514, 516 fold upwards relative to the receiving portion 508 via fold or crease lines 526, 528, 530, 532 located between the receiving portion 508 and the respective outer side panel 510, 512, 514, 516.

Foldably connected to the outer side panels 510, 512, 514, 516 are rear panels 534, 536, 538, 540. The rear panels 534, 536, 538, 540 fold relative to the respective outer side panels 510, 512, 514, 516 via a second set of fold or crease lines 542, 544, 546, 548.

Locking tabs 550, 552 extend transversely from the ends of the rear panel 536 and corresponding locking tabs 554, 556 extend transversely from the ends of the rear panel 540. In the context of the present embodiment, the locking tabs 550, 552, 554, 556 project away from the receiving portion 508.

Each of the rear panels 534, 536, 538, 540 defines an aperture 558, 560, 562, 564 from which the art substrate may be suspended or via which the art substrate may be secured to a vertical surface.

The opposed end portions of the rear panel 534 are angled at an angle of 45° to the fold line 542 such that the side of the rear panel 534 adjacent to the fold line 542 is longer than the opposite side of the rear panel 534. This arrangement provides a first angled end portion 535 and a second angled end portion 537. The rear panel 538 has a similar arrangement in which opposed end portions 539, 541 are angled at 45° to the fold line 546.

The length of the rear panels 536, 540 is substantially identical to the length of the corresponding outer side panels 512, 516.

Extending outwardly from the rear panels 534, 536, 538, 540 are inner side panels 574, 576, 578, 580. The inner side panels 574, 576, 578, 580 are foldable relative to the respective rear panels 534, 536, 538, 540 via fold lines 582, 584, 586, 588. The inner side panels 574, 578 are substantially identical in length to the corresponding outer side panels 510, 514.

Extending outwardly from the respective inner side panels 574, 576, 578, 580 are front panels 590, 592, 594, 596. The front panels 590, 592, 594, 596 are foldable relative to the respective inner side panels 574, 576, 578, 580 via fold lines 598, 600, 602, 604.

To arrange the art substrate 504 in its folded configuration, the outer side panels 510, 514 are rotated upwards about their respective fold lines 526, 530 until the outer side panels 510, 514 are substantially perpendicular to the receiving portion 508. The reinforcing tabs 518, 520 are folded inwards so that they lie parallel to the respective fold line 528. Similarly, the reinforcing tabs 522, 524 are folded inwards so that they lie parallel to the respective fold line 532.

The outer side panels 512, 516 are then rotated upwards about their respective fold lines 528, 532 until the outer side panels 512, 516 are also substantially perpendicular to the receiving portion 508. In this configuration, the reinforcing tabs 518, 520, 522, 524 are located inside the respective outer side panels 512, 516 and lie adjacent to the relevant portions of the outer side panels 512, 516.

The rear panels 534, 536, 538, 540 are then rotated inwardly 90° about their respective fold lines 542, 544, 546, 548 so that the rear panels 534, 536, 538, 540 are parallel to and overlie an outer portion of the receiving portion 508. The rear panels 534, 536, 538, 540 are spaced from the receiving portion by the width of the outer side panels 510, 512, 514, 516.

The locking tab 550 is tucked under the angled end portion 539 which locks the rear panel 536 to the rear panel 538 and at the same time provides an aesthetically pleasing “mitred” appearance for that corner. In a similar way, the locking tab 522 is tucked under the angled end portion 537, the locking tab 522 is tucked under the angled end portion 535, and the locking tab 524 is tucked under the angled end portion 541. In this way, each rear panel is locked to its neighbouring rear panels.

The inner side panels 574, 576, 578, 580 are then rotated 90° about their respective fold lines 582, 584, 586, 588 such that the inner panels 574, 576, 578, 580 are arranged substantially parallel to the outer side panels 510, 512, 514, 516.

The front panels 590, 592, 594, 596 are then folded 90° about their respective fold lines 598, 600, 602, 604 and passed through the respective gaps defined between the inner side panels 574, 576, 578, 580 and the receiving portion 508 such that the front panels 590, 592, 594, 596 are arranged to lie adjacent to the portion of the receiving portion 508 which is overlaid by the rear panels 510, 512, 514, 516.

The frame for the receiving portion 508 can thus be formed without the need for any adhesive.

FIG. 5 shows an embodiment of the third aspect of the invention. This embodiment is based on a modified version of the embodiment shown in FIG. 4 and described hereinabove. The embodiment shown in FIG. 5 is an artwork substrate 702, but in a two-part form. In this embodiment, the receiving portion 508 shown in FIG. 4 is replaced with a border 708 which defines therein a rectangular aperture 708b. The receiving portion is formed by a separate receiving component 708a which is releasably coupled to the frame portion in use. The border and associated frame forming elements are as described above with respect to FIG. 4 and the corresponding reference numerals are used.

As can be seen from FIG. 5, three sides of the frame are arranged in their folded configuration, but one side remains in its planar configuration. This allows the separate receiving component 708a to be slid into the frame. The separate receiving component 708a has dimensions which are greater than the spacings between the opposed inner walls in their folded configuration such that in use, it is located within the gap defined between the border 708 and the front panels 590, 592, 594, 596.

FIG. 6 shows the embodiment shown in FIG. 5 in its fully folded configuration. It will be appreciated that an image on the front facing surface of the separate receiving component 708a is visible through the aperture 708b and is framed by the border 708, whereas an image on the rear facing surface of the receiving component 708a is framed by the frame forming elements.

It will further be appreciated that different images may be provided on different surfaces of the separate receiving component 708a such that the art substrate as a whole is reversible in the sense that the receiving component 708a may be inserted in one of two orientations and may be reversed to display the other image if desired.

It will further be appreciated that if the separate receiving component is relatively thin, then it can be located within the gaps between the front panels and the border with no further modification to the frame forming elements as shown in FIG. 4 and described hereinabove. However, if it is desired to use a relatively thick receiving component 708a, then the width of the inner side panels may be reduced to define a greater gap between front panels and the border 708. Similar reductions in width may also be required of the reinforcing tabs, but this is well within the capabilities of the skilled person.

In a yet further embodiment (not shown in the figures), the receiving portion 508 may remain as a complete rectangular surface and one or more separate receiving components 708a may be provided which is/are secured in location as described hereinabove. It will be appreciated that such an embodiment is not reversible in the sense that the separate receiving component is not visible from the front of the substrate (there is no aperture defined by the receiving portion 508). However, it is reversible in the sense that the front-facing surface of the receiving portion may carry a first image and the separate receiving component may carry a second image (and optionally a third image), wherein the second (or third) image is visible from the rear of the substrate as a whole.

FIG. 7 shows a second embodiment of the invention according to its third aspect. This embodiment provides a two-part art substrate 802 formed from a base component 804 and an image carrying component 806.

The base component is basically a slightly modified version of the art substrate 504 shown in FIG. 4. In this embodiment, the receiving portion 508 of the embodiment shown in FIG. 4 is modified to provide a receiving portion 808a which differs from the receiving portion 508 by the addition of four slots 809a, 809b, 809c, 809d located about the peripheral edge of the receiving portion 808a. Other than the addition of the slots, the base component is identical to the art substrate 504 described hereinabove with reference to FIG. 4.

The image carrying component 806 defines a substantially planar image carrying surface 808b and four securing tabs 811a, 811b, 811c, 811d depending downwards from the image carrying surface 808b (as shown in FIG. 7) and configured to align with the respective slots 809a, 809b, 809c, 809d.

FIG. 8 shows the two-part substrate of FIG. 7 in its assembled state. In this state, the securing tabs 811a, 811b, 811c, 811d are located in the corresponding slots 809a, 809b, 809c, 809d thereby forming a friction fit between the tabs and the slots and securing the image carrying component 806 to the base component 804.

Such an embodiment is useful for calendars and such like, wherein a single base components 804 is provided with twelve different image carrying components 806 and the image carrying components can be changed as the months pass.

1. An artwork substrate including a substantially rectangular receiving portion adapted to receive an art medium, and a frame forming element extending from each side of the receiving portion, wherein each frame forming element includes an outer side panel foldably connected to a respective side of the receiving portion, a rear panel foldably connected to the outer side panel, an inner side panel foldably connected to the rear panel and a front panel foldably connected to the inner side panel; wherein the substrate is formed from a single sheet of substrate material, the substrate has a planar configuration and a folded configuration, and when in the folded configuration the outer side panels extend substantially perpendicularly to the receiving portion, the rear panels are arranged parallel to and spaced from the receiving portion, the inner side panels extend from the rear panels towards the receiving portion such that each inner side panel is opposite and substantially parallel to the respective outer side panel, and the front panels are arranged parallel to and adjacent to the receiving panel, whereby each frame forming element forms a rectangular section frame member on one side of the receiving portion; wherein each frame forming element includes one part of a two-part locking mechanism at each end thereof; and wherein when the frame forming elements are in the folded configuration, adjacent ends of the frame forming elements are secured together by the locking mechanism.

2. An artwork substrate according to claim 1, wherein the substrate material is formed from one or more of a wood pulp material and a polymeric material.

3. An artwork substrate according to claim 2, wherein the substrate material is formed from a laminate comprising a layer of a wood pulp material and a layer of a polymeric material.

4. (canceled)

5. An artwork substrate according to claim 3, wherein the layer of polymeric material has a thickness of 5 micrometers to 50 micrometers.

6. An artwork substrate according to claim 1, wherein the substrate is a multi-layer substrate and includes a canvas layer.

7. An artwork substrate according to claim 1, wherein the receiving portion of the substrate is textured.

8. An artwork substrate according to claim 7, wherein the receiving portion and the outer side panels of the frame forming elements are both textured.

9. An artwork substrate according to claim 1, wherein the frame forming elements are shaped to provide the appearance of mitred corners when in the folded configuration.

10. An artwork substrate according to claim 1, wherein the parts of the two-part locking mechanism are selected from locking tabs, channels and slots, wherein the locking tabs, channels and slots are defined by the respective frame forming elements.

11. (canceled)

12. An artwork substrate according to claim 10, wherein each end of the frame forming elements includes a locking tab, wherein each tab is located within a respective channel defined by the adjacent frame forming element when the substrate is secured in its folded configuration.

13. An artwork substrate according to claim 1, wherein the rear panel of the frame forming elements overlies the respective front panel of the frame forming elements.

14. An artwork substrate according to claim 1, wherein the rear panel and the front panel of each frame forming element have substantially the same width and in the folded configuration, the distal edge of the front panels engages the outer side panel.

15. (canceled)

16. An artwork substrate according to claim 1, wherein one or more of the rear panels defines a mounting aperture via which the substrate may be secured to a vertical surface.

17. An artwork substrate according to claim 1, wherein adjacent outer side panels are joined by a gusset.

18. An artwork substrate according to claim 1, wherein the substrate includes a planar cover element; and the inner side panels each define an elongate slot adapted to receive therein the a planar cover element.

19-20. (canceled)

21. An art substrate blank including a border portion and an artwork substrate according to claim 1 in its planar configuration, wherein the artwork substrate is detachably secured to the border portion by lines of weakness.

22. An art substrate blank according to claim 21, wherein the lines of weakness include perforations.

23. A two-part artwork substrate including a first part comprising a substantially rectangular receiving member adapted to receive thereon an art medium; and a second part comprising a one-piece frame forming element, wherein the receiving member is releasably coupled to the frame forming element, wherein the frame forming element includes a substantially rectangular base panel, four outer side panels each foldably connected to a respective side of the base panel, a rear panel foldably connected to each of the outer side panels, an inner side panel foldably connected to each of the rear panels and a front panel foldably connected to each of the inner side panels; wherein the frame forming element is formed from a single sheet of substrate material, the substrate has a planar configuration and a folded configuration which defines a four-sided rectangular frame, and when in the folded configuration the outer side panels extend substantially perpendicularly from the base panel, the rear panels are arranged parallel to and spaced from the base panel, the inner side panels extend from the rear panels towards the base panel such that each inner side panel is opposite and substantially parallel to the respective outer side panel, and the front panels are arranged parallel to and adjacent to the base panel; wherein each side of the frame forming element includes one part of a two-part locking mechanism at each end thereof; and wherein when the frame forming element is in its folded configuration, adjacent ends of the sides are secured together by the locking mechanism.

24. A two-part artwork substrate according to claim 23, wherein the base panel defines a rectangular aperture therein.

25. A two-part artwork substrate according to claim 23, wherein the frame forming element defines a peripheral channel in its folded configuration, wherein the channel is adapted to receive therein the receiving member.

26. (canceled)
